(19) United States
(12) Patent Application Publication
(10) Pub. No.: US 2026/0016276 A1
(43) Pub. Date: Jan. 15, 2026

(54) HINGE ANGLE DETERMINATION FOR FOLDABLE DEVICE IN SLEEP STATE

(71) Applicant: STMicroelectronics International N.V., Geneva (CH)

(72) Inventors: Tae-gil KANG, Seoul (KR); Hyeok WON, Ui-Wang (KR)

(73) Assignee: STMicroelectronics International N.V., Geneva (CH)

(21) Appl. No.: 18/767,489

(22) Filed: Jul. 9, 2024

(51) Int. Cl. G01B 5/24; G06F 1/16; G06F 1/3296

(52) U.S. Cl. CPC G01B 5/24; G06F 1/1641; G06F 1/3296

(57) ABSTRACT

The present disclosure is directed to hinge angle detection for electronic devices in a sleep state. An example method includes determining, during a sleep state of a device, whether the device is in an activity condition or an inactivity condition; and responsive to determining that the device is in the activity condition—causing a first sensor unit and a second sensor unit to operate in an operating mode, and determining an angle based on the first orientation and the second orientation determined during the operating mode. Both sensor units include an accelerometer and a gyroscope, and are configured to, during the operating mode, determine an orientation based on measurements by accelerometer and gyroscope.

### BACKGROUND

### Technical Field

The present disclosure is directed to hinge angle determination for foldable electronic devices.

### Description of the Related Art

Hinge angle determination involves determining the angle between two lid components of a foldable electronic device, such as a laptop, tablet, or other foldable mobile device, that fold on to each other about a hinge or folding portion. Typically, one of the two lid components includes a display, and the other of the two lid components includes a user input device, such as a keyboard, or another display.

The angle between the two lid components is often referred to as a hinge angle or lid angle. Generally, the hinge angle of a foldable electronic device is equal to zero degree when the foldable electronic device is in a closed state (e.g., the face of the first lid component is placed against the face of the second lid component), and can range up to 360 degrees when the foldable electronic device is in a fully open state (e.g., the back of the first lid component is placed against the back of the second lid component).

As foldable electronic devices are becoming more popular, there is a need for more efficient, accurate, and flexible techniques to determine hinge angle and thereby facilitate various functionalities associated with lid folding.

### BRIEF SUMMARY

The present disclosure is directed to hinge or lid angle determination for foldable devices, such as a tablet or laptop with a display and a keyboard that can unfold up to 360 degrees. Illustratively, if a user unfolds the keyboard part for using other interface (e.g., stylus-pen, haptic, or the like), inputs from the keyboard should be blocked. To properly block inputs from the keyboard, the angle between the display and the keyboard should be determined. However, the hinge angle may be changed, advertently or inadvertently, between laptop mode (0-180 degrees) and tablet mode (180-360 degrees) while the device is in sleep state, which can cause unexpected responses or undesirable user experience due to delayed or otherwise inaccurate hinge angle detection. Traditional solutions typically require constant hinge angle calculation even when the device is in sleep state, with sensors and hinge angle computation running all the time, which lead to high power consumption and high computational cost even in the sleep state.

To address at least these challenges, the presently disclosed technology provides efficient and accurate hinge angle determination mechanisms. The various embodiments disclosed herein provide a device, including a first component that includes: a first sensor unit including a first accelerometer, a first gyroscope, and a first processor, wherein the first processor is configured to determine, during an operating mode, a first orientation of the first component based on measurements by the first accelerometer and the first gyroscope; a second component coupled to the first component, the first and second components configured to rotate with respect to a hinge axis, the second component including a second sensor unit that includes a second accelerometer, a second gyroscope, and a second processor, the second processor configured to determine, during the operating mode, a second orientation of the second component based on measurements by the second accelerometer and the second gyroscope; and a third processor coupled to the first sensor unit and the second sensor unit, the third processor configured to: determine, during a sleep state of the device, whether the device is in an activity condition or an inactivity condition; responsive to determining that the device is in the activity condition: cause the first sensor unit and the second sensor unit to operate in the operating mode; and determine an angle between the first component and the second component based on the first orientation and the second orientation determined during the operating mode.

The various embodiments disclosed herein provide a method, including determining, during a sleep state of a device, whether the device is in an activity condition or an inactivity condition; responsive to determining that the device is in the activity condition: causing a first sensor unit and a second sensor unit to operate in an operating mode, wherein the first sensor unit includes a first accelerometer and a first gyroscope, and is configured to determine, during the operating mode, a first orientation based on measurements by the first accelerometer and the first gyroscope, and wherein the second sensor unit includes a second accelerometer and a second gyroscope, and is configured to determine, during the operating mode, a second orientation based on measurements by the second accelerometer and the second gyroscope; and determining an angle based on the first orientation and the second orientation determined during the operating mode.

The various embodiments disclosed herein provide a device, including a first sensor unit; a first housing including the first sensor unit, the first sensor unit configured to determine, during an operating mode, a first orientation of the first housing based on measurements generated by the first sensor unit; a second sensor unit; a second housing coupled to the first housing, the first and second housings configured to rotate with respect to a hinge axis, the second housing including the second sensor unit, the second sensor unit configured to determine, during the operating mode, a second orientation of the second housing based on measurements generated by the second sensor unit; and a processor configured to: determine, during a sleep state of the device, whether the device is in an activity condition or an inactivity condition; responsive to determining that the device is in the activity condition: cause the first sensor unit and the second sensor unit to operate in the operating mode; and determine an angle between the first housing and the second housing based on the first orientation and the second orientation determined during the operating mode.

### BRIEF DESCRIPTION OF THE SEVERAL VIEWS OF THE DRAWINGS

In the drawings, identical reference numbers identify similar features or elements. The size and relative positions of features in the drawings are not necessarily drawn to scale.

FIG. 1A is a conceptual diagram showing a device according to some embodiments disclosed herein.

FIG. 1B shows an example of the device in laptop mode.

FIG. 1C shows an example of the device in tablet mode.

FIG. 2 is a block diagram of the device according to some embodiments disclosed herein.

FIG. 3 shows an example table of settings for a typical hinge angle determination mechanism.

FIG. 4 shows an example table of settings for a hinge angle determination mechanism in accordance with some embodiments of the presently disclosed technology.

FIG. 5 shows an example table of settings for a hinge angle determination mechanism in accordance with other embodiments of the presently disclosed technology.

FIG. 6 is an example flow diagram of a stationary check process 600 according to some embodiments disclosed herein.

FIG. 7 is an example flow diagram of a hinge angle determination process 700 according to some embodiments disclosed herein.

### DETAILED DESCRIPTION

In the following description, certain specific details are set forth in order to provide a thorough understanding of various aspects of the disclosed subject matter. However, the disclosed subject matter may be practiced without these specific details. In some instances, well-known structures and methods of manufacturing electronic components, foldable devices, and sensors have not been described in detail to avoid obscuring the descriptions of other aspects of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout the specification to “one embodiment,” “an embodiment,” or “some embodiments” means that a particular feature, structure, or characteristic described in connection with the embodiment is included in at least one embodiment. Thus, the appearance of the phrases “in one embodiment,” “in an embodiment,” or “in some embodiments” in various places throughout the specification are not necessarily all referring to the same aspect. Furthermore, the particular features, structures, or characteristics may be combined in any suitable manner in one or more aspects of the present disclosure.

As discussed above, typical hinge angle determination solutions are high cost and have high power consumption even when a foldable electronic device is in sleep state. The present disclosure is directed to an efficient and accurate hinge angle detection solution, which functions to save on power and cost while a foldable electronic device is in sleep state.

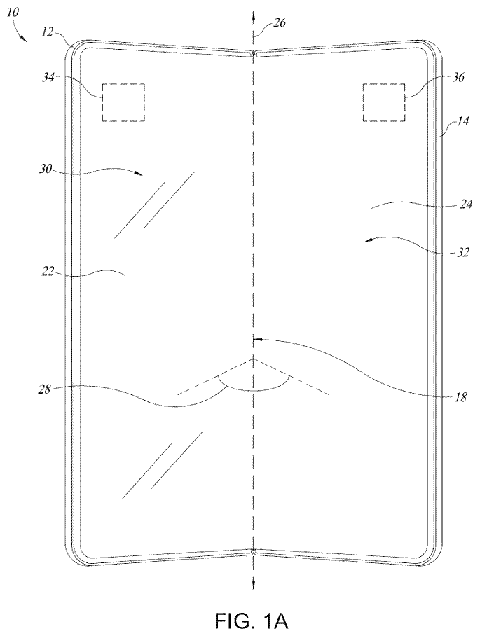

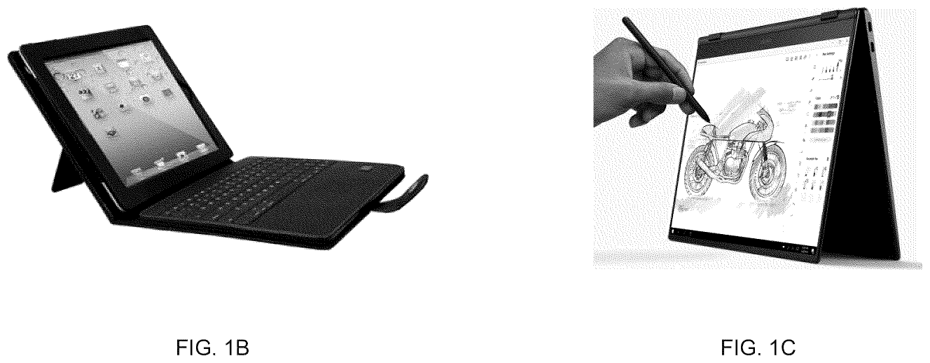

FIG. 1A is a conceptual diagram showing a device 10 according to some embodiments disclosed herein. Illustratively, the device 10 is a foldable computing device, such as a notebook or tablet computer. The device 10 may also be another type of device, such as a foldable smart phone. The device 10 includes a first lid component 12, a second lid component 14, and a hinge 18.

Each of the first lid component 12 and the second lid component 14 includes a casing or housing that houses internal components (e.g., processors, sensors, capacitors, resistors, amplifiers, speakers, etc.) of the device 10. As will be discussed in further detail below, a first sensor unit 34 and a second sensor unit 36 are housed within the first lid component 12 and the second lid component 14, respectively.

The first lid component 12 and the second lid component 14 include a first user interface 22 and a second user interface 24, respectively. In the embodiment shown in FIGS. 1A and 1n the embodiments discussed below, the first user interface 22 is a display and the second user interface 24 is a user input device (e.g., a keyboard). However, each of the first user interface 22 and the second user interface 24 may be a display (e.g., a monitor, touch screen, etc.), a user input device (e.g., buttons, a keyboard, etc.), and/or another type of user interface.

The first lid component 12 and the second lid component 14 fold onto, or away from, each other, similar to a book, about the hinge 18. The first lid component 12 and the second lid component 14 rotate relative to a hinge axis 26. The hinge 18 may be any type of mechanism that allows the first lid component 12 and the second lid component 14 to rotate relative to the hinge axis 26 (e.g., up to 360 degrees).

As will be discussed in further detail below, the device 10 performs hinge angle determination to determine a hinge angle 28 between the first lid component 12 and the second lid component 14. The hinge angle 28 is the angle between a first surface 30 of the first lid component 12, more specifically the first user interface 22, and a second surface 32 of the second lid component 14, more specifically the second user interface 24. The hinge angle 28 is equal to zero degree when the foldable electronic device is in a closed state (e.g., the first surface 30 faces the second surface 32), and 360 degrees when the foldable electronic device is in a fully open state (e.g., the first surface 30 and the second surface 32 face are back-to-back facing opposite directions).

FIG. 1B shows an example of the device 10 in laptop mode, and FIG. 1C shows an example of the device 10 in tablet mode. Illustratively, the hinge angle 28 determines whether the device 10 (e.g., a table computer) is in a particular operating mode. For example, if a user of the device unfolds the keyboard part beyond certain angle for using another interface, such as a stylus-pen, haptic, etc., inputs from keyboard should be blocked in that particular operating mode.

In some embodiments, the device 10 is in laptop mode when the hinge angle 28 is between 0 and 180 degrees, and the device 10 is in tablet mode when the hinge angle 28 is between 180 and 360 degrees. In tablet mode, input from keyboard should be blocked; in laptop mode, the operating system (OS) of the device should be woken up by input from keyboard.

However, the user of the device 10 may cause the hinge angle to change while the device is in sleep state, which can be problematic if the resulting hinge angle is not properly determined, and the correct operating mode not set. For example, in laptop mode, the user may turn off the screen (causing the device to enter sleep state) and change the hinge angle to 360 degrees for using as a tablet; then someone or something accidentally pushes the keyboard, which wakes up the OS. This is problematic because input from keyboard should have been blocked. As another example, in tablet mode, the user may turn off the screen (causing the device to enter sleep state) and change the hinge angle to under 180 degrees for using as laptop; then the user pushes keyboard to wake up OS, which does not respond. This is also problematic because input from keyboard should have been allowed.

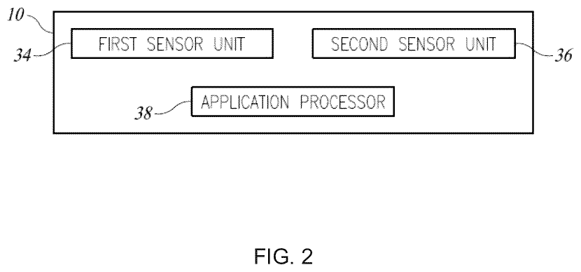

FIG. 2 is a block diagram of the device 10 according to some embodiments disclosed herein. The device 10 includes a first sensor unit 34, a second sensor unit 36, and an application processor 38.

Each of the first sensor unit 34 and the second sensor unit 36 is a multi-sensor device that includes one or more types of sensors including, but not limited to, one or more accelerometers, one or more gyroscopes, one or more hall sensors, or the like. The accelerometer can measure acceleration along one or more axe. The gyroscope can measures angular velocity along one or more axes.

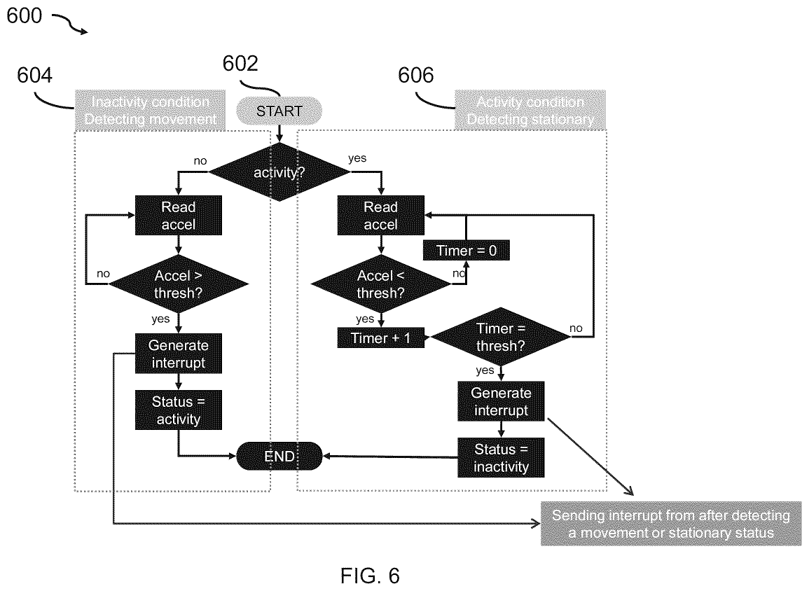

Each of the first sensor unit 34 and the second sensor unit 36 can also include its own onboard memory and processor. The processor can be configured to process data generated by the sensors, and execute simple programs, such as finite state machines and decision tree logic. The processor can perform at least some part of the functions disclosed herein, e.g., process 600 of FIG. 6.

The first sensor unit 34 and the second sensor unit 36 are positioned in the first lid component 12 and the second lid component 14, respectively. As will be discussed in further detail below, the first sensor unit 34 and the second sensor unit 36 can determine orientations of the first lid component 12 and the second lid component 14, respectively, as a basis for hinge angle determination.

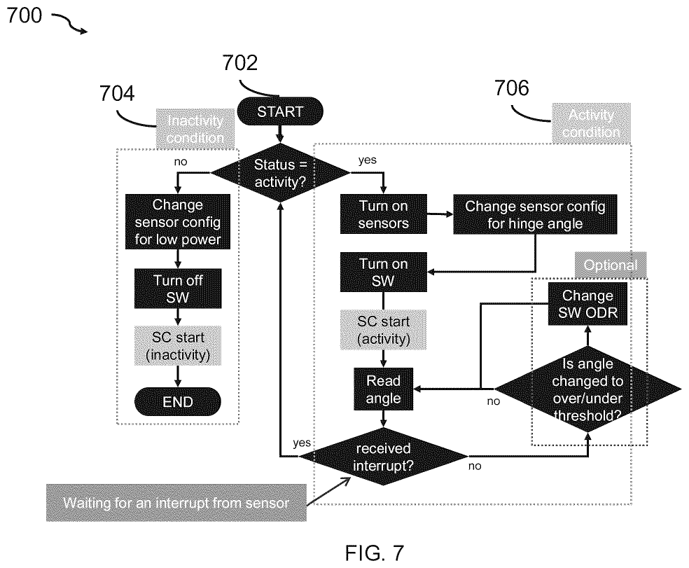

The application processor 38 can include one or more general purpose processing unit(s). The application processor 38 can be any type of processor(s), controller(s), or signal processor(s) configured to process data. In some embodiments, the application processor 38 is the device's 10 own general purpose processor that, along with processing data for hinge angle determination discussed below, is utilized to process data for the operating system, user applications, and other types of software of the device 10. As will be discussed in further detail below (e.g., in the context of process 700 of FIG. 7), the application processor 38 can process the orientations determined by the first lid component 12 and the second lid component 14 to determine a hinge angle value of the device 10, and set the corresponding operating mode for the device 10 in accordance with the determined hinge angle.

The application processor 38 can be positioned within the first lid component 12, along with the first sensor unit 34; or the second lid component 14, along with the second sensor unit 36. The first sensor unit 34 and the second sensor unit 36 can communicate with the application processor 38 in accordance with applicable interfaces or protocols, e.g., the Improved Inter Integrated Circuit (I3C) standard.

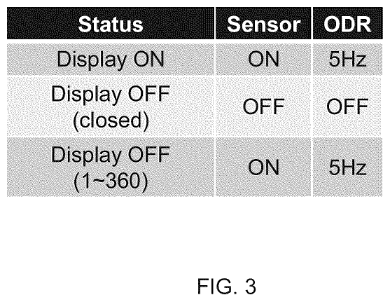

FIG. 3 shows an example table of settings for a typical hinge angle determination mechanism. In such a typical mechanism, in order to avoid the problematic situations associated with sleep state, the hinge angle determination is constantly calculated, even when the device 10 is in sleep state (e.g., with display turned off). The senor units (e.g., including both accelerometer(s) and gyroscope(s)) and the hinge angle calculation software (e.g., implemented via the application processor 38) are constantly working, resulting in high power consumption even in sleep state (e.g., due to active sensor hub and inter-component communication, such as I3C communication). Corresponding output data rate (ODR) from the hinge angle calculation software remains high (e.g., at 5 Hz). Only in the case where the device 10 is fully folded (e.g., 0 degree as detected by a hall sensor), the sensor units and the hinge angle calculation software are turn off.

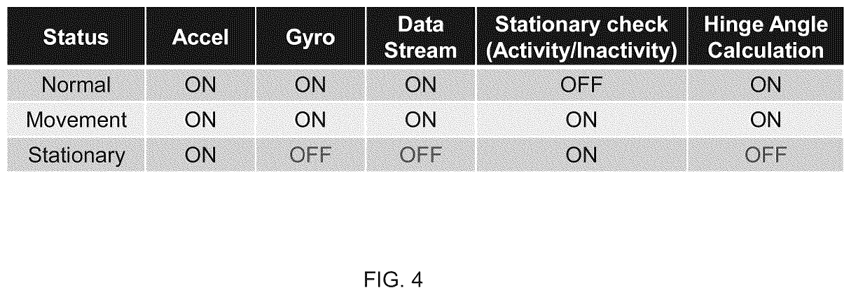

FIG. 4 shows an example table of settings for a hinge angle determination mechanism in accordance with some embodiments of the presently disclosed technology. In these embodiments, a stationary or movement condition can be detected for the device 10 while it is in sleep state. ON/OFF status of one type of sensor (e.g., gyroscope), power mode, ODR of another type of sensor (e.g., accelerometer) can be changed responsive to the detection of the stationary or movement condition. For example, in sleep state and movement condition of the device 10, the accelerometer, gyroscope, and bus for data stream stay ON for calculating hinge angle; in sleep state and stationary condition of the device 10, the accelerometers stay ON for detecting movement, but the gyroscope and bus for data stream are turned OFF and hinge angle calculation (e.g., via a hinge angle library, driver, or other software) is suspended or stopped to provide significant savings on power consumption and computational cost.

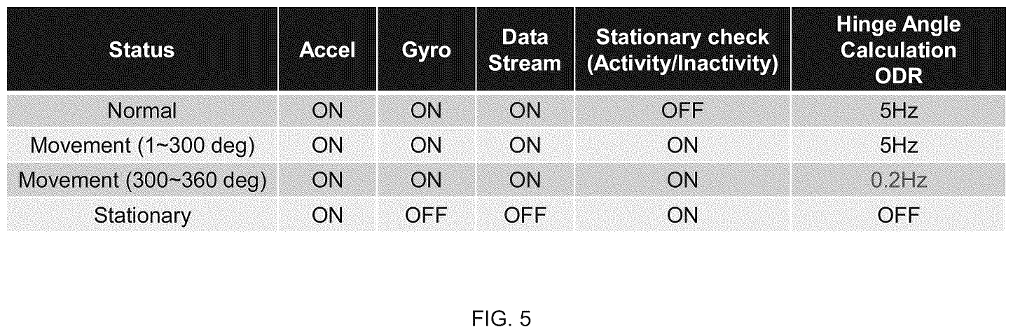

FIG. 5 shows an example table of settings for a hinge angle determination mechanism in accordance with other embodiments of the presently disclosed technology. In these embodiments, as compared with the embodiments of FIG. 4, a slower ODR of hinge angle calculation can be applied in specific hinge angle range(s). This can relate to a user's carry status of the device 10. For example, the user may unfold fully to 360 degrees when carrying a device. At a nearby threshold range (e.g., between 300 degrees and 360 degrees), there can be a hysteresis (user will define) to avoid high ODR and further save on power consumption and computational cost. In some embodiments, the threshold range for changing ODR can be adjusted prior to launching the device 10.

FIG. 6 is an example flow diagram of a stationary check process 600 according to some embodiments disclosed herein. Illustratively, the process 600 can be performed by the first sensor unit 34, the second sensor unit 36, or both.

The process 600 starts at block 602, and proceeds to determine whether the device 10 is in an activity (movement) condition or an inactivity (stationary) condition. Illustratively, an activity flag or other indication of the device's current condition can be checked to make this determination.

If it is determined that the device 10 is in the inactivity condition, the process 600 proceeds to an inactivity condition subprocess 604 to detect movement of the device 10. Illustratively, this can be achieved by recursively reading the accelerometer(s) of the first and/or second sensor units and comparing the readings with a threshold. If one or more most recent readings exceed the threshold, a corresponding interrupt can be generated and sent to the application processor 38, e.g., via I3C communications. The process 600 then proceeds to set an activity condition for the device 10, e.g., by changing the activity flag or other indication accordingly.

Otherwise, if it is determined that the device 10 is in the activity condition, the process 600 proceeds to an activity condition subprocess 606 to detect stationary status of the device 10. Illustratively, this can be achieved by recursively reading the accelerometer(s) of the first and/or second sensor units and comparing the readings with a threshold, which may or may not be the same threshold as used in the inactivity condition subprocess. Here, a cushion of time can be built in to prevent premature detection of the stationary status; in other words, the device 10 need to be stable (e.g., accelerometer readings below the threshold) for a period of time before it is considered to be stationary. As shown in FIG. 6, a timer with a count threshold can be used to implement the cushion of time. Once the timer meets the threshold, a corresponding interrupt can be generated and sent to the application processor 38, e.g., via I3C communications. The process 600 then proceeds to set an inactivity condition for the device 10, e.g., by changing the activity flag or other indication accordingly.

FIG. 7 is an example flow diagram of a hinge angle determination process 700 according to some embodiments disclosed herein. Illustratively, the process 700 can be performed by the application processor 38.

The process 700 starts at block 702 (e.g., when triggered by an interrupt received from the first and/or second sensor unit), and proceeds to determine whether the device 10 is in an activity (movement) condition or an inactivity (stationary) condition. Illustratively, an activity flag or other indication of the device's current condition can be checked to make this determination.

If it is determined that the device 10 is in the inactivity condition, the process 700 proceeds to an inactivity condition subprocess 704 to save power. Illustratively, this can be achieved by changing sensor configurations for the first and/or second sensor units for low power operation (e.g., turning off gyroscope(s), setting accelerometer(s) to low power mode, setting ODR of accelerometer(s) to slower rate, combination of the same or the like). The application processor 38 can also refrain from performing hinge angle calculation (e.g., by turning off corresponding hinge angle calculation software), providing further power and computational cost savings. The process 700 then proceeds to cause execution of the process 600, in particular, its inactivity subprocess 604.

Otherwise, if it is determined that the device 10 is in the activity condition, the process 700 proceeds to an activity condition subprocess 706 to determine hinge angle. Illustratively, this can be achieved by turning on all applicable sensors of the first and/or second sensor units and changing sensor configurations for accurate orientation detecting and hinge angle calculation. For example, the gyroscope(s) and accelerometer(s) can be set to high performance mode or high power mode, and the ODR of them set to normal rate. The application processor 38 also initiates (e.g., by turning on corresponding hinge angle calculation software) and continuously performs hinge angle calculation based on inputs, e.g., via I3C communications, from the first and second sensor units. The process 700 then proceeds to cause execution of the process 600, in particular, its activity subprocess 606. The calculated hinge angle can be read to determine the correct operating mode (e.g., laptop mode, tablet mode, or the like) or other status, and thereby facilitate proper functioning of the device 10 and resulting user experience. The process 700 proceeds to await an interrupt from the first and/or second sensor units. If the interrupt is received, the process 700 proceeds back to determine whether the device 10 is in an activity (movement) condition or an inactivity (stationary) condition; if not, the process 700 can proceed back to read the updated hinge angle as calculated. In some embodiments, depending on whether the hinge angle is within an angle range (e.g., based on threshold(s)), the ODR of hinge angle calculation is changed before the next read.

The various embodiments disclosed herein provide a device, including a first component that includes: a first sensor unit including a first accelerometer, a first gyroscope, and a first processor, wherein the first processor is configured to determine, during an operating mode, a first orientation of the first component based on measurements by the first accelerometer and the first gyroscope; a second component coupled to the first component, the first and second components configured to rotate with respect to a hinge axis, the second component including a second sensor unit that includes a second accelerometer, a second gyroscope, and a second processor, the second processor configured to determine, during the operating mode, a second orientation of the second component based on measurements by the second accelerometer and the second gyroscope; and a third processor coupled to the first sensor unit and the second sensor unit, the third processor configured to: determine, during a sleep state of the device, whether the device is in an activity condition or an inactivity condition; responsive to determining that the device is in the activity condition: cause the first sensor unit and the second sensor unit to operate in the operating mode; and determine an angle between the first component and the second component based on the first orientation and the second orientation determined during the operating mode.

In some embodiments, determining, during the sleep state of the device, whether the device is in the activity condition or the inactivity condition is based on at least an interrupt received from at least one of the first sensor unit or the second sensor unit. In some embodiments, the interrupt is generated based on detecting a stationary status or movement status of the device by at least one of the first sensor unit or the second sensor unit.

In some embodiments, causing the first sensor unit and the second sensor unit to operate in the operating mode comprises causing at least the first accelerometer, the first gyroscope, the second accelerometer, and the second gyroscope to operate in a high performance mode or high power mode.

In some embodiments, causing the first sensor unit and the second sensor unit to operate in the operating mode comprises causing output data rate (ODR) of at least the first sensor unit and the second sensor to be set to a normal rate.

In some embodiments, the third processor is configured to: responsive to determining that the device is in the inactivity condition: cause the first sensor unit and the second sensor unit to operate in a low power mode; and refrain from determining the angle between the first component and the second component. In some embodiments, causing the first sensor unit and the second sensor unit to operate in the low power mode comprises causing at least the first accelerometer and the second accelerometer to operate in a low power mode. In some embodiments, causing the first sensor unit and the second sensor unit to operate in the low power mode comprises causing at least the first gyroscope and the second gyroscope to turn off. In some embodiments, causing the first sensor unit and the second sensor unit to operate in the low power mode comprises causing output data rate (ODR) of at least the first sensor unit and the second sensor to be set to a slow rate.

The various embodiments disclosed herein provide a method, including determining, during a sleep state of a device, whether the device is in an activity condition or an inactivity condition; responsive to determining that the device is in the activity condition: causing a first sensor unit and a second sensor unit to operate in an operating mode, wherein the first sensor unit includes a first accelerometer and a first gyroscope, and is configured to determine, during the operating mode, a first orientation based on measurements by the first accelerometer and the first gyroscope, and wherein the second sensor unit includes a second accelerometer and a second gyroscope, and is configured to determine, during the operating mode, a second orientation based on measurements by the second accelerometer and the second gyroscope; and determining an angle based on the first orientation and the second orientation determined during the operating mode.

In some embodiments, determining, during the sleep state of the device, whether the device is in the activity condition or the inactivity condition is based on at least an interrupt received from at least one of the first sensor unit or the second sensor unit.

In some embodiments, causing the first sensor unit and the second sensor unit to operate in the operating mode comprises causing at least the first accelerometer, the first gyroscope, the second accelerometer, and the second gyroscope to operate in a high performance mode or high power mode.

In some embodiments, causing the first sensor unit and the second sensor unit to operate in the operating mode comprises causing output data rate (ODR) of at least the first sensor unit and the second sensor to be set to a normal rate.

In some embodiments, the method includes responsive to determining that the device is in the inactivity condition: causing the first sensor unit and the second sensor unit to operate in a low power mode; and refraining from determining the angle between the first component and the second component. In some embodiments, causing the first sensor unit and the second sensor unit to operate in the low power mode comprises causing at least the first accelerometer and the second accelerator to operate in a low power mode. In some embodiments, causing the first sensor unit and the second sensor unit to operate in the low power mode comprises causing at least the first gyroscope and the second gyroscope to turn off. In some embodiments, causing the first sensor unit and the second sensor unit to operate in the low power mode comprises causing output data rate (ODR) of at least the first sensor unit and the second sensor to be set to a slow rate.

The various embodiments disclosed herein provide a device, including a first sensor unit; a first housing including the first sensor unit, the first sensor unit configured to determine, during an operating mode, a first orientation of the first housing based on measurements generated by the first sensor unit; a second sensor unit; a second housing coupled to the first housing, the first and second housings configured to rotate with respect to a hinge axis, the second housing including the second sensor unit, the second sensor unit configured to determine, during the operating mode, a second orientation of the second housing based on measurements generated by the second sensor unit; and a processor configured to: determine, during a sleep state of the device, whether the device is in an activity condition or an inactivity condition; responsive to determining that the device is in the activity condition: cause the first sensor unit and the second sensor unit to operate in the operating mode; and determine an angle between the first housing and the second housing based on the first orientation and the second orientation determined during the operating mode.

In some embodiments, causing the first sensor unit and the second sensor unit to operate in the operating mode comprises causing at least the first accelerometer, the first gyroscope, the second accelerometer, and the second gyroscope to operate in a high performance mode or high power mode.

In some embodiments, the processor is configured to: responsive to determining that the device is in the inactivity condition: cause the first sensor unit and the second sensor unit to operate in a low power mode; and refrain from determining the angle between the first housing and the second housing.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a first component including:
a first sensor unit including a first accelerometer, a first gyroscope, and a first processor, wherein the first processor is configured to determine, during an operating mode, a first orientation of the first component based on measurements by the first accelerometer and the first gyroscope;
a second component coupled to the first component, the first and second components configured to rotate with respect to a hinge axis, the second component including:
a second sensor unit including a second accelerometer, a second gyroscope, and a second processor, the second processor configured to determine, during the operating mode, a second orientation of the second component based on measurements by the second accelerometer and the second gyroscope; and
a third processor coupled to the first sensor unit and the second sensor unit, the third processor configured to:
determine, during a sleep state of the device, whether the device is in an activity condition or an inactivity condition;
responsive to determining that the device is in the activity condition:
cause the first sensor unit and the second sensor unit to operate in the operating mode; and
determine an angle between the first component and the second component based on the first orientation and the second orientation determined during the operating mode.

2. The device of claim 1 wherein determining, during the sleep state of the device, whether the device is in the activity condition or the inactivity condition is based on at least an interrupt received from at least one of the first sensor unit or the second sensor unit.

3. The device of claim 2 wherein the interrupt is generated based on detecting a stationary status or movement status of the device by at least one of the first sensor unit or the second sensor unit.

4. The device of claim 1 wherein causing the first sensor unit and the second sensor unit to operate in the operating mode comprises causing at least the first accelerometer, the first gyroscope, the second accelerometer, and the second gyroscope to operate in a high power mode.

5. The device of claim 1 wherein causing the first sensor unit and the second sensor unit to operate in the operating mode comprises causing output data rate (ODR) of at least the first sensor unit and the second sensor to be set to a normal rate.

6. The device of claim 1 wherein the third processor is configured to:
responsive to determining that the device is in the inactivity condition:
cause the first sensor unit and the second sensor unit to operate in a low power mode; and
refrain from determining the angle between the first component and the second component.

7. The device of claim 6 wherein causing the first sensor unit and the second sensor unit to operate in the low power mode comprises causing at least the first accelerometer and the second accelerator to operate in a low power mode.

8. The device of claim 6 wherein causing the first sensor unit and the second sensor unit to operate in the low power mode comprises causing at least the first gyroscope and the second gyroscope to turn off.

9. The device of claim 6 wherein causing the first sensor unit and the second sensor unit to operate in the low power mode comprises causing output data rate (ODR) of at least the first sensor unit and the second sensor to be set to a slow rate.

10. A method, comprising:
determining, during a sleep state of a device, whether the device is in an activity condition or an inactivity condition;
responsive to determining that the device is in the activity condition:
causing a first sensor unit and a second sensor unit to operate in an operating mode, wherein the first sensor unit includes a first accelerometer and a first gyroscope, and is configured to determine, during the operating mode, a first orientation based on measurements by the first accelerometer and the first gyroscope, and wherein the second sensor unit includes a second accelerometer and a second gyroscope, and is configured to determine, during the operating mode, a second orientation based on measurements by the second accelerometer and the second gyroscope; and
determining an angle based on the first orientation and the second orientation determined during the operating mode.

11. The method of claim 10 wherein determining, during the sleep state of the device, whether the device is in the activity condition or the inactivity condition is based on at least an interrupt received from at least one of the first sensor unit or the second sensor unit.

12. The method of claim 10 wherein causing the first sensor unit and the second sensor unit to operate in the operating mode comprises causing at least the first accelerometer, the first gyroscope, the second accelerometer, and the second gyroscope to operate in a high power mode.

13. The method of claim 10 wherein causing the first sensor unit and the second sensor unit to operate in the operating mode comprises causing output data rate (ODR) of at least the first sensor unit and the second sensor to be set to a normal rate.

14. The method of claim 10, comprising:
responsive to determining that the device is in the inactivity condition:
causing the first sensor unit and the second sensor unit to operate in a low power mode; and
refraining from determining the angle between the first component and the second component.

15. The method of claim 14 wherein causing the first sensor unit and the second sensor unit to operate in the low power mode comprises causing at least the first accelerometer and the second accelerator to operate in a low power mode.

16. The method of claim 14 wherein causing the first sensor unit and the second sensor unit to operate in the low power mode comprises causing at least the first gyroscope and the second gyroscope to turn off.

17. The method of claim 14 wherein causing the first sensor unit and the second sensor unit to operate in the low power mode comprises causing output data rate (ODR) of at least the first sensor unit and the second sensor to be set to a slow rate.

18. A device, comprising:
a first sensor unit;
a first housing including the first sensor unit, the first sensor unit configured to determine, during an operating mode, a first orientation of the first housing based on measurements generated by the first sensor unit;
a second sensor unit;
a second housing coupled to the first housing, the first and second housings configured to rotate with respect to a hinge axis, the second housing including the second sensor unit, the second sensor unit configured to determine, during the operating mode, a second orientation of the second housing based on measurements generated by the second sensor unit; and
a processor configured to:
determine, during a sleep state of the device, whether the device is in an activity condition or an inactivity condition;
responsive to determining that the device is in the activity condition:
cause the first sensor unit and the second sensor unit to operate in the operating mode; and
determine an angle between the first housing and the second housing based on the first orientation and the second orientation determined during the operating mode.

19. The device of claim 18 wherein causing the first sensor unit and the second sensor unit to operate in the operating mode comprises causing at least the first accelerometer, the first gyroscope, the second accelerometer, and the second gyroscope to operate in a high power mode.

20. The device of claim 18 wherein the processor is configured to:
responsive to determining that the device is in the inactivity condition:
cause the first sensor unit and the second sensor unit to operate in a low power mode; and
refrain from determining the angle between the first housing and the second housing.
